(19) United States
(12) Patent Application Publication
(10) Pub. No.: US 2025/0350209 A1
(43) Pub. Date: Nov. 13, 2025

(54) POWER CONVERTER HAVING ON-TIME COMPENSATION MECHANISM

(71) Applicant: ANPEC ELECTRONICS CORPORATION, HSINCHU (TW)

(72) Inventor: TZU-YANG YEN, TAIPEI CITY (TW)

(21) Appl. No.: 18/784,897

(22) Filed: Jul. 25, 2024

(30) Foreign Application Priority Data
May 9, 2024 (TW) 113117113

(51) Int. Cl. H02M 3/335; H02M 1/00; H02M 3/158

(52) U.S. Cl. CPC H02M 3/33515; H02M 1/0012; H02M 3/1582

(57) ABSTRACT

A power converter having an on-time compensation mechanism is provided. The power converter includes a first switch, a second switch, a third switch, a fourth switch and a control circuit. A first terminal of the first switch is coupled with an input voltage. A first terminal of the second switch is connected to a second terminal of the first switch and a first terminal of an inductor. A first terminal of the fourth switch is connected to a second terminal of the third switch and a second terminal of the inductor. The control circuit, according to an on-time of the fourth switch operating in a boost mode, compensates on-times of the first and the second switches operating in a buck mode. In a buck-boost mode, the control circuit controls the on-times of the first and the second switches to be equal to the compensated on-times, respectively.

### CROSS-REFERENCE TO RELATED PATENT APPLICATION

This application claims the benefit of priority to Taiwan Patent Application No. 113117113, filed on May 9, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a power converter, and more particularly to a power converter having an on-time compensation mechanism.

### BACKGROUND OF THE DISCLOSURE

Power converters are indispensable for electronic devices. The power converters are used to adjust power and supply the adjusted power to the electronic devices. Switch components of the power converter must be switched according to voltages or currents of circuit components in the power converter, such that the power converter supplies appropriate power to a load.

However, a controller circuit of a conventional power converter cannot effectively control on-times of the switch components. In particular, the conventional controller circuit directly adds the on-times of the switch components operating in a buck mode to the on-times of the switch components operating in a boost mode to obtain times as on-times of the switch components operating in a buck-boost mode. As a result, the switch components of the power converter are switched at too low a frequency, which causes a low operating efficiency of the power converter. Therefore, the conventional power converter cannot effectively supply power to the load.

### SUMMARY OF THE DISCLOSURE

In response to the above-referenced technical inadequacies, the present disclosure provides a power converter having an on-time compensation mechanism. The power converter includes power converter and a control circuit. The switch circuit includes a plurality of switch components. Each of the plurality of switch components includes a first switch, a second switch, a third switch and a fourth switch. A first terminal of the first switch as an input node is coupled with an input voltage. A first terminal of the second switch is connected to a second terminal of the first switch. A node between the first terminal of the second switch and the second terminal of the first switch is connected to a first terminal of an inductor. A second terminal of the second switch is grounded. A first terminal of the third switch as an output node is connected to an output terminal of the power converter. A voltage at the output node is used as an output voltage of the power converter. A first terminal of the fourth switch is connected to a second terminal of the third switch. A node between the first terminal of the fourth switch and the second terminal of the third switch is connected to a second terminal of the inductor. A second terminal of the fourth switch is grounded. The control circuit is connected to a control terminal of each of the plurality of switch components, the input node and the output node. The control circuit switches the switch circuit to change the input voltage and the output voltage such that the power converter switches between a buck mode, a buck-boost mode and a boost mode. The control circuit compensates on-times of some of the plurality of switch components operating in the buck mode according to an on-time of one of the plurality of switch components operating in the boost mode. The control circuit controls on-times of the some of the plurality of switch components in the buck-boost mode to equal to the on-times that are compensated, respectively.

As described above, the present disclosure provides the power converter having the on-time compensation mechanism. The power converter of the present disclosure compensates the on-times of the switch components operating in the buck mode according to the on-times of the switch components operating in the boost mode. The power converter of the present disclosure controls the on-times of the switch components operating in the buck-boost mode to be equal to the compensated on-times. Therefore, when the power converter of the present disclosure switches from the buck mode to the buck-boost mode, a frequency that the switching components of the power converter are switched is controlled at an appropriate value, thereby improving an operational efficiency of the power converter of the present disclosure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of a power converter having an on-time compensation mechanism according to a first embodiment of the present disclosure;

FIG. 2 is a schematic diagram of modes between which the power converter having the on-time compensation mechanism is switched according to the first embodiment to a fifth embodiment of the present disclosure;

FIG. 3 is a block diagram of the power converter having the on-time compensation mechanism according to the second embodiment of the present disclosure;

FIG. 4 is a circuit diagram of a control circuit of the power converter having the on-time compensation mechanism according to the third embodiment of the present disclosure;

FIG. 5 is a circuit diagram of the power converter having the on-time compensation mechanism according to the fourth embodiment of the present disclosure; and

FIG. 6 is a circuit diagram of the power converter having the on-time compensation mechanism according to the fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

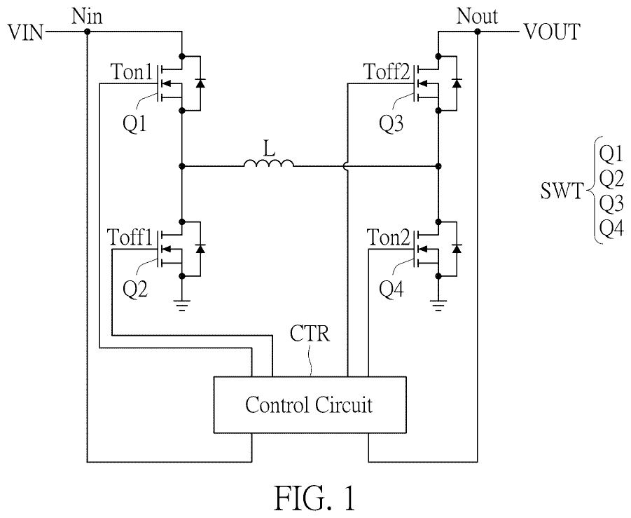

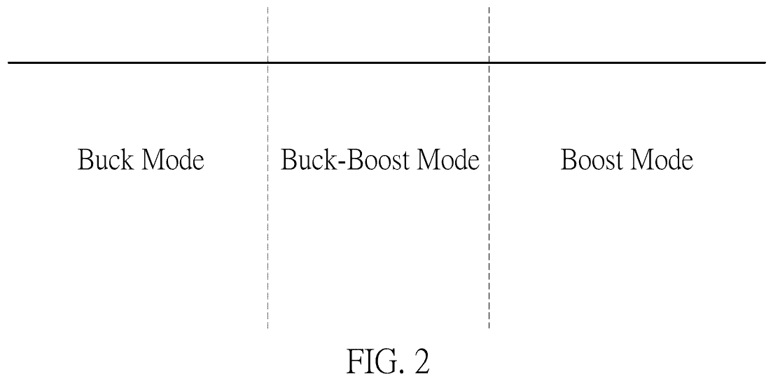

Reference is made to FIG. 1 and FIG. 2, in which FIG. 1 is a circuit diagram of a power converter having an on-time compensation mechanism according to a first embodiment of the present disclosure, and FIG. 2 is a schematic diagram of modes between which the power converter having the on-time compensation mechanism is switched according to the first embodiment to a fifth embodiment of the present disclosure.

In the first embodiment, the power converter of the present disclosure includes a switch circuit SWT and a control circuit CTR as shown in FIG. 1.

The control circuit CTR includes a first switch Q1, a second switch Q2, a third switch Q3 and a fourth switch Q4 as shown in FIG. 1, but the present disclosure is not limited thereto.

A first terminal of the first switch Q1 is coupled with an input voltage VIN. A voltage of an input node Nin between the first terminal of the first switch Q1 and an input voltage VIN is equal to the input voltage VIN.

A first terminal of the second switch Q2 is connected to a second terminal of the first switch Q1. A node between the first terminal of the second switch Q2 and the second terminal of the first switch Q1 is connected to a first terminal of an inductor L. A second terminal of the inductor L is grounded.

A first terminal of the third switch Q3 is connected to an output terminal of the power converter of the present disclosure. The output terminal of the power converter of the present disclosure is connected to a load. A node between the first terminal of the third switch Q3 and the output terminal of the power converter of the present disclosure is used as an output node Nout, and a voltage of the output node Nout is used as an output voltage VOUT.

A first terminal of the fourth switch Q4 is connected to a second terminal of the third switch Q3. A node between the first terminal of the fourth switch Q4 and the second terminal of the third switch Q3 is connected to a second terminal of the inductor L. A second terminal of the fourth switch Q4 is grounded.

The control circuit CTR is connected to a control terminal of the first switch Q1, a control terminal of the second switch Q2, a control terminal of the third switch Q3, a control terminal of the fourth switch Q4, and the input node Nin.

The control circuit CTR switches the switch circuit SWT for changing the voltage of the input node Nin between the first terminal of the first switch Q1 and the input voltage VIN and changing the output voltage VOUT of the output node Nout between the first terminal of the third switch Q3 and the output terminal of the power converter of the present disclosure. As a result, the power converter of the present disclosure switches between a buck mode, a buck-boost mode and a boost mode as shown in FIG. 2.

In the buck mode, the control circuit CTR may complementarily switch the first switch Q1 and the second switch Q2, continually turn on the third switch Q3, and continually turn off the fourth switch Q4. For example, within a working period of a buck on-time signal, the control circuit CTR may turn on the first switch Q1 and turn off the second switch Q2. Within a non-working period of the buck on-time signal, the control circuit CTR may turn off the first switch Q1 and turn on the second switch Q2. That is, in the buck mode, the working period of the buck on-time signal is an on-time Ton1 of the first switch Q1, and the non-working period of the buck on-time signal is an on-time Toff1 of the second switch Q2.

In the boost mode, the control circuit CTR may complementarily switch the third switch Q3 and the fourth switch Q4, continually turn on the first switch Q1, and continually turn off the second switch Q2. For example, within a working period of a boost on-time signal, the control circuit CTR may turn on the fourth switch Q4 and turn off the third switch Q3. Within a non-working period of the boost on-time signal, the control circuit CTR may turn off the fourth switch Q4 and turn on the third switch Q3. That is, in the boost mode, the working period of the boost on-time signal is an on-time Ton2 of the fourth switch Q4, and the non-working period of the boost on-time signal is an on-time Toff2 of the third switch Q3.

It is worth noting that, if a sum of on-time of each of the plurality of switch components (including the first switch Q1, the second switch Q2, the third switch Q3 and the fourth switch Q4) of the switch circuit SWT operating in the buck mode and the on-time of each of the plurality of switch components of the switch circuit SWT operating in the boost mode is directly used as the on-time of each of the plurality of switch components of the switch circuit SWT operating in the buck-boost mode, the power converter has a poor operating efficiency.

Therefore, the control circuit CTR, according to the on-time of one of the plurality of switch components (including the first switch Q1, the second switch Q2, the third switch Q3 and the fourth switch Q4) of the switch circuit SWT operating in the boost mode, compensates the on-times of some of the plurality of switch components of the switch circuit SWT operating in the buck mode to generate compensated on-times.

In the buck-boost mode, the control circuit CTR controls the on-times of the some of the plurality of switch components (such as the on-time Ton1 of the first switch Q1 and the on-time Toff1 of the second switch Q2) are respectively equal to the compensated on-times.

In the buck-boost mode, the control circuit CTR may complementarily switch the first switch Q1, the second switch Q2, the third switch Q3 and the fourth switch Q4.

For example, the control circuit CTR may, according to the on-time Ton2 of the fourth switch Q4 operating in the boost mode, compensate the on-time Ton1 of the first switch Q1 operating in the buck mode to form the compensated on-time of the first switch Q1. In the buck-boost mode, the control circuit CTR controls the on-time Ton1 of the first switch Q1 to be equal to the compensated on-time of the first switch Q1.

For example, the control circuit CTR may, according to the on-time Ton2 of the fourth switch Q4 operating in the boost mode, compensate the on-time Toff1 of the second switch Q2 operating in the buck mode to form the compensated on-time of the second switch Q2. In the buck-boost mode, the control circuit CTR controls the on-time Toff1 of the second switch Q2 to be equal to the compensated on-time of the second switch Q2.

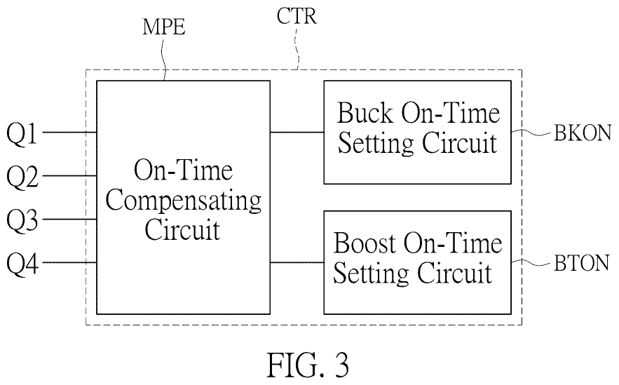

Reference is made to FIG. 3, which is a block diagram of the power converter having the on-time compensation mechanism according to the second embodiment of the present disclosure.

The control circuit CTR of the power converter of the present disclosure as shown in FIG. 1 may include a buck on-time setting circuit BKON, a boost on-time setting circuit BTON and an on-time compensating circuit MPE as shown in FIG. 3.

The buck on-time setting circuit BKON and the boost on-time setting circuit BTON may be connected to the input node Nin between the first terminal of the first switch Q1 and the input voltage VIN, and may be connected to the output node Nout between the first terminal of the third switch Q3 and the output terminal of the power converter of the present disclosure.

The on-time compensating circuit MPE is connected to the buck on-time setting circuit BKON, the boost on-time setting circuit BTON, the control terminal of the first switch Q1, the control terminal of the second switch Q2, the control terminal of the third switch Q3 and the control terminal of the fourth switch Q4.

The buck on-time setting circuit BKON sets the on-times of the first switch Q1, the second switch Q2, the third switch Q3 and the fourth switch Q4 that operate in the buck mode to output the buck on-time signal.

In the buck mode, the on-time compensating circuit MPE controls the on-time of the first switch Q1, the on-time of the second switch Q2, the on-time of the third switch Q3 and the on-time of the fourth switch Q4 according to the buck on-time signal from the buck on-time setting circuit BKON.

The boost on-time setting circuit BTON sets the on-times of the first switch Q1, the second switch Q2, the third switch Q3 and the fourth switch Q4 that operate in the boost mode to output the boost on-time signal.

In the boost mode, the on-time compensating circuit MPE controls the on-time of the first switch Q1, the on-time of the second switch Q2, the on-time of the third switch Q3 and the on-time of the fourth switch Q4 according to the boost on-time signal from the boost on-time setting circuit BTON.

It is worth noting that, the on-time compensating circuit MPE, according to the on-times of the plurality of switch components (such as the first switch Q1, the second switch Q2, the third switch Q3 and the fourth switch Q4) operating in the boost mode, and compensates the on-times of the plurality of switch components operating in the buck mode to generate the compensated on-times. The on-time compensating circuit MPE controls the on-times of the plurality of switch components operating in the buck-boost mode to be equal to the compensated on-times respectively.

When the on-time compensating circuit MPE of the control circuit CTR calculates the on-time Ton1 of the first switch Q1 operating in the buck-boost mode, the on-time compensating circuit MPE of the control circuit CTR may subtract the on-time Ton2 of the fourth switch Q4 operating in the boost mode from a total time during which the switch circuit SWT (including the first switch Q1, the second switch Q2, the third switch Q3 and the fourth switch Q4) operating in the buck mode to obtain a compensation time difference.

Then, the on-time compensating circuit MPE of the control circuit CTR may divide the output voltage VOUT of the output node Nout between the first terminal of the third switch Q3 and the output terminal of the power converter of the present disclosure by the input voltage VIN to obtain a value, and then multiply the value by the compensation time difference to obtain the compensated on-time of the first switch Q1.

In the boost mode, the on-time compensating circuit MPE of the control circuit CTR controls the on-time Ton1 of the first switch Q1 to be equal to the compensated on-time of the first switch Q1.

The on-time compensating circuit MPE calculates the on-time Ton1 of the first switch Q1 operating in the buck-boost mode by using an equation of:

$$VIN \times Ton 2 + ( VIN - VOUT ) \times ( Ton 1 - Ton 2 ) = VOUT \times ( T - Ton 1 ) \to Ton 1 = VOUT / VIN \times ( T - Ton 2 ) ,$$

wherein VIN represents the input voltage, the voltage of the input node Nin between the first terminal of the first switch Q1 and the input voltage VIN is equal to the input voltage VIN, Ton2 represents the on-time of the fourth switch Q4 operating in the boost mode, VOUT represents the output voltage of the output node Nout between the first terminal of the third switch Q3 and the output terminal of the power converter of the present disclosure, Ton1 represents the on-time of the first switch Q1 operating in the buck-boost mode, and T represents the total time during which the switch circuit SWT operates in the buck mode.

For example, when the on-time compensating circuit MPE of the control circuit CTR calculates the on-time Toff1 of the second switch Q2 operating in the buck-boost mode, the on-time compensating circuit MPE of the control circuit CTR may subtract the output voltage VOUT of the output node Nout between the first terminal of the third switch Q3 and the output terminal of the power converter of the present disclosure from the input voltage VIN to obtain a first arithmetic value. Then, the on-time compensating circuit MPE may divide the first arithmetic value by the input voltage VIN to obtain a first value and multiply the first value by the total time during which the switch circuit SWT operates in the buck mode to obtain a second arithmetic value.

Then, the on-time compensating circuit MPE of the control circuit CTR may divide the output voltage VOUT by the input voltage VIN to obtain a second value, and multiply the second value by the on-time Ton2 of the fourth switch Q4 operating in the boost mode to obtain a third arithmetic value. Finally, the on-time compensating circuit MPE may add up the second arithmetic value and the third arithmetic value to obtain the compensated on-time of the second switch Q2.

In the buck-boost mode, the on-time compensating circuit MPE of the control circuit CTR controls the on-time Toff1 of the second switch Q2 to be equal to the compensated on-time of the second switch Q2.

The on-time compensating circuit MPE calculates the on-time Toff1 of the second switch Q2 operating in the buck-boost mode by using an equation of:

$$VIN \times Ton 2 + ( VIN - VOUT ) \times ( T - Toff 1 - Ton 2 ) = VOUT \times Toff 1 \to Toff 1 = ( VIN - VOUT ) / VIN \times T + VOUT / VIN \times Ton 2 ,$$

wherein VIN represents the input voltage, the voltage of the input node Nin between the first terminal of the first switch Q1 and the input voltage VIN is equal to the input voltage VIN, Ton2 represents the on-time of the fourth switch Q4 operating in the boost mode, VOUT represents the output voltage of the output node Nout between the first terminal of the third switch Q3 and the output terminal of the power converter of the present disclosure, Ton1 represents the on-time of the first switch Q1 operating in the buck-boost mode, and T represents the total time during which the switch circuit SWT operates in the buck mode.

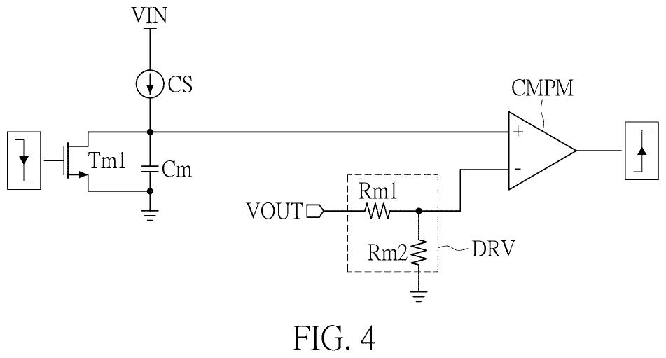

Reference is made to FIG. 4, which is a circuit diagram of a control circuit of the power converter having the on-time compensation mechanism according to the third embodiment of the present disclosure.

The buck on-time setting circuit BKON of the control circuit CTR of the power converter of the present disclosure as shown in FIG. 3 may include a transistor Tm1, a current source CS, a capacitor Cm, a voltage divider circuit DRV and a comparator CMPM as shown in FIG. 4.

A control terminal of the transistor Tm1 shown in FOG. 4 may be connected to an external on-time instructing circuit, and receives an on-time preset signal from the external on-time instructing circuit.

An input terminal of the current source CS shown in FIG. 4 is connected to the input node Nin between the first terminal of the first switch Q1 and the input voltage VIN as shown in FIG. 1, and receives the input voltage VIN from the input node Nin.

As shown in FIG. 4, a first terminal of the capacitor Cm is connected to an output terminal of the current source CS and a first terminal of the transistor Tm1. A second terminal of the transistor Tm1 and a second terminal of the capacitor Cm are grounded.

An input terminal of the voltage divider circuit DRV shown in FIG. 4 is connected to the output node Nout between the first terminal of the third switch Q3 and the output terminal of the power converter of the present disclosure as shown in FIG. 1, and receives the output voltage VOUT from the output node Nout.

For example, as shown in FIG. 4, the voltage divider circuit DRV may include a first voltage dividing resistor Rm1 and a second voltage dividing resistor Rm2. A first terminal of the first voltage dividing resistor Rm1 is connected to the output node Nout between the first terminal of the third switch Q3 and the output terminal of the power converter of the present disclosure. A first terminal of the second voltage dividing resistor Rm2 is connected to a second terminal of the first voltage dividing resistor Rm1. A second terminal of the second voltage dividing resistor Rm2 is grounded.

A first input terminal such as a non-inverting input terminal of the comparator CMPM is connected to the first terminal of the capacitor Cm. A second input terminal such as an inverting input terminal of the comparator CMPM is connected to an output terminal of the voltage divider circuit DRV (that is a node between the first terminal of the second voltage dividing resistor Rm2 and the second terminal of the first voltage dividing resistor Rm1). An output terminal of the comparator CMPM is connected to the control terminal of the first switch Q1.

In the buck mode, the comparator CMPM compares a voltage of the first input terminal of the comparator CMPM with a voltage of the second input terminal of the comparator CMPM to output the buck on-time signal to the control terminal of the first switch Q1. As a result, the first switch Q1 is turned on within the working period of the buck on-time signal, and is turned off within the non-working period of the buck on-time signal.

That is, the working period of the buck on-time signal received by the control terminal of the first switch Q1 is the on-time Ton1 of the first switch Q1 operating in the buck mode.

The on-time Ton1 of the first switch Q1 operating in the buck mode may be calculated by using equations of:

$$Ton 1 = VOUT \times ( K \times C / ICS ) , and \\ K = R2 / ( R 1 + R 2 ) ,$$

wherein Ton1 represents the on-time of the first switch Q1 operating in the buck mode, K represents an uncompensated magnification coefficient, ICS represents a current outputted by the current source CS, the current outputted by the current source CS is proportional to the input voltage VIN, C represents a capacitance of the capacitor Cm, VOUT represents the output voltage of the output node Nout between the first terminal of the third switch Q3 and the output terminal of the power converter of the present disclosure, VIN represents the voltage of the input node Nin between the first terminal of the first switch Q1 and the input voltage, R1 represents a resistance of the first voltage dividing resistor Rm1, and R2 represents a resistance of the second voltage dividing resistor Rm2.

It is worth noting that, when the power converter switches from the buck mode to the buck-boost mode, the on-time Ton1 of the first switch Q1 is calculated by using an equation of:

$$Ton 1 = VOUT / VIN ( T - Ton 2 ) = VOUT / VIN ( K \times C / ICS - Ton 2 ) ,$$

wherein Ton1 represents the on-time of the first switch Q1 operating in the buck-boost mode, VOUT represents the output voltage of the output node Nout between the first terminal of the third switch Q3 and the output terminal of the power converter of the present disclosure, VIN represents the voltage of the input node Nin between the first terminal of the first switch Q1 and the input voltage, T represent a total time during which the switch circuit SWT operates in the buck mode, Ton2 represent a total time during which the fourth switch Q4 operates in the boost mode, K represents the uncompensated magnification coefficient, ICS represents the current outputted by the current source CS, the current outputted by the current source CS is proportional to the input voltage VIN, and C represents the capacitance of the capacitor Cm.

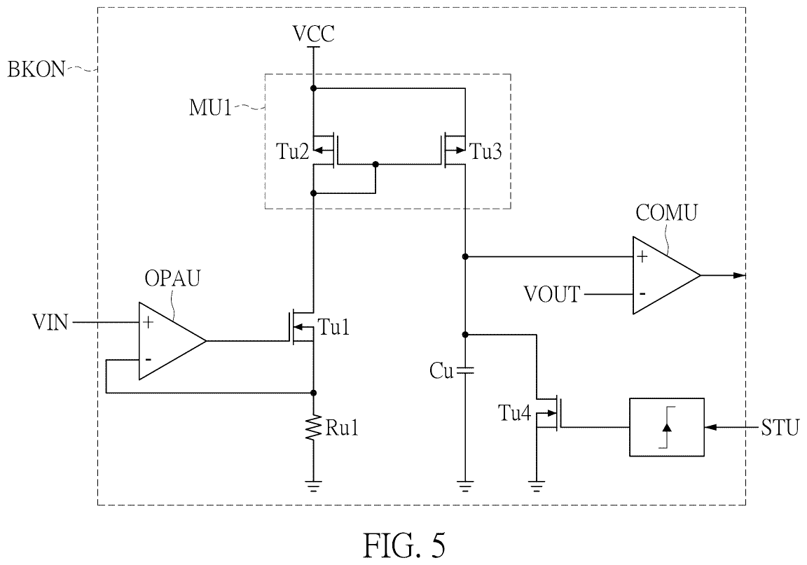

Reference is made to FIG. 5, which is a circuit diagram of the power converter having the on-time compensation mechanism according to the fourth embodiment of the present disclosure.

The buck on-time setting circuit BKON of the control circuit CTR shown in FIG. 3 may be the same as the buck on-time setting circuit BKON shown in FIG. 5.

As shown in FIG. 5, the buck on-time setting circuit BKON may include an operational amplifier OPAU, a first transistor Tu1, a current mirror MU1, a resistor Ru1, a comparator COMU, a capacitor Cu and a fourth transistor Tu4, some of which may be omitted in practice.

A first input terminal such as a non-inverting input terminal of the operational amplifier OPAU shown in FIG. 5 is connected to the input node Nin between the first terminal of the first switch Q1 and the input voltage VIN as shown in FIG. 1, and receives the input voltage VIN from the input node Nin. A control terminal of the first transistor Tu1 is connected to an output terminal of the operational amplifier OPAU.

As shown in FIG. 5, a first terminal of the resistor Ru1 is connected to a second terminal of the first transistor Tu1 and a second input terminal such as an inverting input terminal of the operational amplifier OPAU. A second terminal of the first transistor Tu1 is grounded.

The current mirror MU1 includes a second transistor Tu2 and a third transistor Tu3. A first terminal of the second transistor Tu2 is coupled with a common voltage VCC. A second terminal of the second transistor Tu2 is an output terminal of the current mirror MU1 and is connected to a first terminal of the first transistor Tu1.

A first terminal of the third transistor Tu3 is coupled with the common voltage VCC. A control terminal of the third transistor Tu3 is connected to a control terminal and the second terminal of the second transistor Tu2. A second terminal of the third transistor Tu3 is an output terminal of the current mirror MU1 and is connected to a first input terminal such as a non-inverting input terminal of the comparator COMU.

A second input terminal such as an inverting input terminal of the comparator COMU shown in FIG. 5 is connected to the output node Nout between the first terminal of the third switch Q3 and the output terminal of the power converter of the present disclosure as shown in FIG. 1, and receives the output voltage VOUT from the output node Nout.

A first terminal of the capacitor Cu is connected to the first input terminal such as the non-inverting input terminal of the comparator COMU. A second terminal of the capacitor Cu is grounded.

A first terminal of the fourth transistor Tu4 is connected to the first input terminal such as the non-inverting input terminal of the comparator COMU. A second terminal of the fourth transistor Tu4 is grounded. A control terminal of the fourth transistor Tu4 receives a setting signal STU from an external setting circuit.

An output terminal of the comparator COMU of the buck on-time setting circuit BKON shown in FIG. 5 is connected to an input terminal of the on-time compensating circuit MPE shown in FIG. 3.

In the boost mode, the on-time compensating circuit MPE shown in FIG. 3 transmits the buck on-time signal from the output terminal of the comparator COMU of the buck on-time setting circuit BKON to the control terminal of the first switch Q1 shown in FIG. 1.

In the buck mode, the on-time of the first switch Q1 is calculated by using equations of:

$$Ton 1 = ( C / gm ) \times VOUT / VIN , and \\ T = C / gm ,$$

wherein Ton1 represents the on-time of the first switch Q1 operating in the buck mode, gm is equal to 1/Ru1, C represents the capacitance of the capacitor Cu, VOUT represents the output voltage of the output node Nout between the first terminal of the third switch Q3 and the output terminal of the power converter of the present disclosure, VIN represents the input voltage, and the voltage of the input node Nin between the first terminal of the first switch Q1 and the input voltage VIN is equal to the input voltage VIN.

In the buck mode, the first switch Q1 and the second switch Q2 are complementarily switched. That is, when the first switch Q1 is turned on, the second switch Q2 is turned off. When the first switch Q1 is turned off, the second switch Q2 is turned on.

It is worth noting that, the on-time compensating circuit MPE compensates the working period of the buck on-time signal from the output terminal of the comparator COMU of the buck on-time setting circuit BKON to generate the compensated on-time of the first switch Q1, and compensates the non-working period of the buck on-time signal to generate the compensated on-time of the second switch Q2. The working period of the buck on-time signal is the on-time of the first switch Q1 operating in the buck mode. The non-working period of the buck on-time signal is the on-time of the second switch Q2 operating in the buck mode.

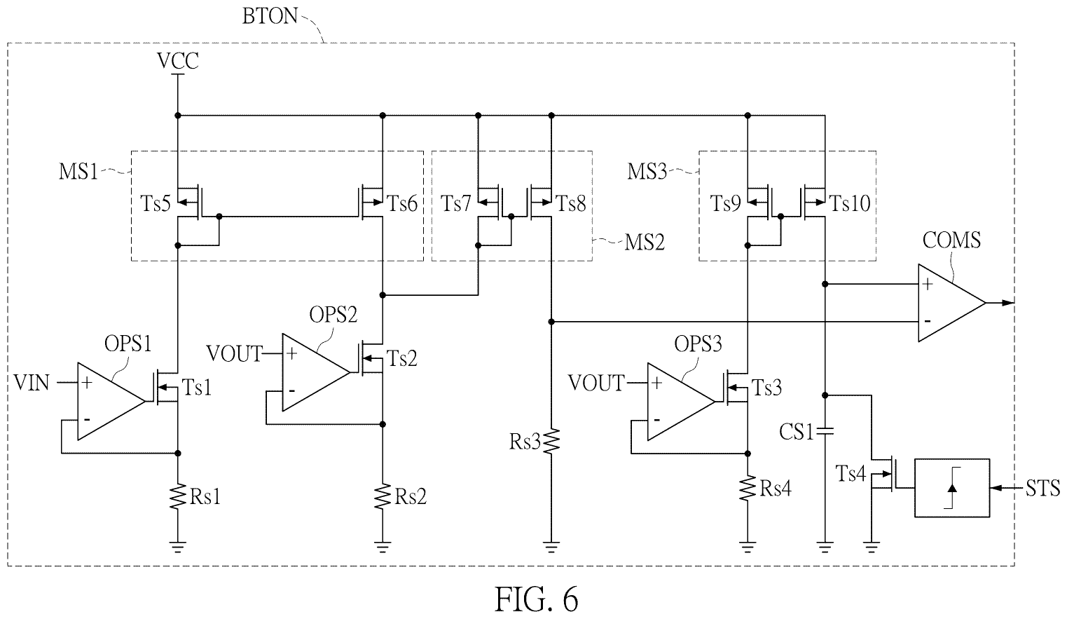

Reference is made to FIG. 6, which is a circuit diagram of the power converter having the on-time compensation mechanism according to the fifth embodiment of the present disclosure.

The boost on-time setting circuit BTON of the control circuit CTR shown in FIG. 3 may be the same as the boost on-time setting circuit BTON shown in FIG. 6.

As shown in FIG. 6, the boost on-time setting circuit BTON may include a first operational amplifier OPS1, a first transistor Ts1, a first current mirror MS1, a first resistor Rs1, a second operational amplifier OPS2, a second transistor Ts2, a second resistor Rs2, a comparator COMS, a second current mirror MS2, a third operational amplifier OPS3, a third transistor Ts3, a third resistor Rs3, a third current mirror MS3, a capacitor CS1, a fourth transistor Ts4 and a fourth resistor Rs4, some of which may be omitted in practice.

A first input terminal such as a non-inverting input terminal of the first operational amplifier OPS1 as shown in FIG. 6 is connected to the input node Nin between the first terminal of the first switch Q1 and the input voltage VIN, and receives the input voltage VIN from the input node Nin as shown in FIG. 1. A second input terminal such as an inverting input terminal of the first operational amplifier OPS1 is connected to a first terminal of the first resistor Rs1. An output terminal of the first operational amplifier OPS1 is connected to a control terminal of the first transistor Ts1. A second terminal of the first transistor Ts1 is connected to the first terminal of the first resistor Rs1. A second terminal of the first resistor Rs1 is grounded.

The first current mirror MS1 includes a fifth transistor Ts5 and a sixth transistor Ts6. A first terminal of the fifth transistor Ts5 and a first terminal of the sixth transistor Ts6 are coupled with the common voltage VCC. A second terminal of the fifth transistor Ts (that is an input terminal of the first current mirror MS1) is connected to a first terminal of the first transistor Ts1. A control terminal of the sixth transistor Ts6 is connected to a control terminal and the second terminal of the fifth transistor Ts5.

A first input terminal such as a non-inverting input terminal of the second operational amplifier OPS2 shown in FIG. 6 is connected to the output node Nout between the first terminal of the third switch Q3 and the output terminal of the power converter of the present disclosure as shown in FIG. 1, and receives the output voltage VOUT from the output node Nout.

As shown in FIG. 6, a first terminal of the second transistor Ts2 is connected to a second terminal of the sixth transistor Ts6 (that is an output terminal of the first current mirror MS1). A control terminal of the second transistor Ts2 is connected to an output terminal of the second operational amplifier OPS2.

A first terminal of the second resistor Rs2 is connected to the second transistor Ts2 and a second input terminal such as an inverting input terminal of the second operational amplifier OPS2. A second terminal of the second resistor Rs2 is grounded.

The second current mirror MS2 includes a seventh transistor Ts7 and an eighth transistor Ts8. A first terminal of the seventh transistor Ts7 is coupled with the common voltage VCC. A second terminal of the seventh transistor Ts7 (that is an input terminal of the second current mirror MS2) is connected to a node between the second terminal of the sixth transistor Ts6 (that is the output terminal of the first current mirror MS1) and the first terminal of the second transistor Ts2.

A first terminal of the eighth transistor Ts8 is coupled with the common voltage VCC. A control terminal of the eighth transistor Ts8 is connected to a control terminal and the second terminal of the seventh transistor Ts7. A second terminal of the eighth transistor Ts8 is connected to a first terminal of the third resistor Rs3. A second terminal of the third resistor Rs3 is grounded.

The third current mirror MS3 includes a ninth transistor Ts9 and a tenth transistor Ts10.

A first terminal of the ninth transistor Ts9 is coupled with the common voltage VCC. A second terminal of the ninth transistor Ts9 (that is an input terminal of the third current mirror MS3) is connected to a first terminal of the third transistor Ts3. A second terminal of the third transistor Ts3 is connected to a first terminal of the fourth resistor Rs4. A second terminal of the fourth resistor Rs4 is grounded. A control terminal of the third transistor Ts3 is connected to an output terminal of the third operational amplifier OPS3.

A first input terminal such as a non-inverting input terminal of the third operational amplifier OPS3 is connected to the output node Nout between the first terminal of the third switch Q3 and the output terminal of the power converter of the present disclosure. A second input terminal such as an inverting input terminal of the third operational amplifier OPS3 and the second terminal of the third transistor Ts3 are connected to the first terminal of the fourth resistor Rs4.

A first terminal of the tenth transistor Ts10 is coupled with the common voltage VCC. A control terminal of the tenth transistor Ts10 is connected to a control terminal and the second terminal of the ninth transistor Ts9.

A first input terminal such as a non-inverting input terminal of the comparator COMS is connected to a second terminal of the tenth transistor Ts10 (that is an output terminal of the third current mirror MS3). A second input terminal such as an inverting input terminal of the comparator COMS is connected to the second terminal of the eighth transistor Ts8 and the first terminal of the third resistor Rs3.

The first terminal of the capacitor CS1 is connected to the first input terminal such as the non-inverting input terminal of the comparator COMS. The second terminal of the capacitor CS1 is grounded.

The first terminal of the fourth resistor Rs4 is connected to the first input terminal such as the non-inverting input terminal of the comparator COMS. A second terminal of the fourth resistor Rs4 is grounded. A control terminal of the fourth resistor Rs4 receives the setting signal STU from the external setting circuit.

An output terminal of the comparator COMS of the boost on-time setting circuit BTON shown in FIG. 6 is connected to the input terminal of the on-time compensating circuit MPE shown in FIG. 3. An output terminal of the on-time compensating circuit MPE shown in FIG. 3 is connected to the control terminal of the fourth switch Q4 shown in FIG. 1, and outputs the boost on-time signal to the control terminal of the fourth switch Q4.

In the boost mode, the on-time of the fourth switch Q4 is calculated by using equations of:

$$Ton 2 = ( K \times Rs 4 \times C ) \times ( VOUT - VIN ) / VOUT , and \\ T = K \times Rs 4 \times C ,$$

wherein Ton2 represents the on-time of the fourth switch Q4 operating in the boost mode, K=Rs3/Rs1, Rs1=Rs2, C represents the capacitance of the capacitor CS1, VOUT represents the output voltage of the output node Nout between the first terminal of the third switch Q3 and the output terminal of the power converter of the present disclosure, VIN represents the input voltage, and the voltage of the input node Nin between the first terminal of the first switch Q1 and the input voltage VIN is equal to the input voltage VIN

It is worth noting that, the on-time compensating circuit MPE may, according to the working period of the boost on-time signal from the output terminal of the comparator COMS of the boost on-time setting circuit BTON, compensate the working period and the non-working period of the buck on-time signal from the output terminal of the comparator COMU of the buck on-time setting circuit BKON. The working period of the boost on-time signal is the on-time of the fourth switch Q4 operating in the boost mode. The working period of the buck on-time signal is the on-time of the first switch Q1 operating in the buck mode. The non-working period of the buck on-time signal is the on-time of the second switch Q2 operating in the buck mode.

In conclusion, the present disclosure provides the power converter having the on-time compensation mechanism. The power converter of the present disclosure compensates the on-times of the switch components operating in the buck mode according to the on-times of the switch components operating in the boost mode. The power converter of the present disclosure controls the on-times of the switch components operating in the buck-boost mode to be equal to the compensated on-times. Therefore, when the power converter of the present disclosure switches from the buck mode to the buck-boost mode, a frequency that the switching components of the power converter are switched is controlled at an appropriate value, thereby improving an operational efficiency of the power converter of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power converter having an on-time compensation mechanism, comprising:
a switch circuit including a plurality of switch components, wherein each of the plurality of switch components includes:
a first switch, wherein a first terminal of the first switch as an input node is coupled with an input voltage;
a second switch, wherein a first terminal of the second switch is connected to a second terminal of the first switch, a node between the first terminal of the second switch and the second terminal of the first switch is connected to a first terminal of an inductor, and a second terminal of the second switch is grounded; and
a third switch, wherein a first terminal of the third switch as an output node is connected to an output terminal of the power converter, and a voltage at the output node is used as an output voltage of the power converter; and
a fourth switch, wherein a first terminal of the fourth switch is connected to a second terminal of the third switch, a node between the first terminal of the fourth switch and the second terminal of the third switch is connected to a second terminal of the inductor, and a second terminal of the fourth switch is grounded; and
a control circuit connected to a control terminal of each of the plurality of switch components, the input node and the output node;
wherein the control circuit switches the switch circuit to change the input voltage and the output voltage such that the power converter switches between a buck mode, a buck-boost mode and a boost mode;
wherein the control circuit compensates on-times of a number of the plurality of switch components operating in the buck mode according to an on-time of one of the plurality of switch components operating in the boost mode, and the control circuit controls on-times of the number of the plurality of switch components in the buck-boost mode to equal to the on-times that are compensated, respectively.

2. The power converter according to claim 1, wherein, in the buck mode, the control circuit complementarily switches the first switch and the second switch, continually turns on the third switch, and continually turns off the fourth switch.

3. The power converter according to claim 1, wherein, in the boost mode, the control circuit complementarily switches the third switch and the fourth switch, continually turns on the first switch, and continually turns off the second switch.

4. The power converter according to claim 1, wherein, in the buck-boost mode, the control circuit complementarily switches the first switch, the second switch, the third switch and the fourth switch.

5. The power converter according to claim 1, wherein the control circuit subtracts the on-time of the fourth switch operating in the boost mode from a total time during which the switch circuit operates in the buck mode to obtain a compensation time difference, and the control circuit divides the output voltage by the input voltage to obtain a value, and multiplies the value by the compensation time difference to obtain a compensated on-time;
wherein, in the buck-boost mode, the control circuit controls the on-time of the first switch to be equal to the compensated on-time.

6. The power converter according to claim 1, wherein the control circuit subtracts the output voltage from the input voltage to obtain a first arithmetic value, then divides the first arithmetic value by the input voltage to obtain a first value, then multiplies the first value by a total time during which the switch circuit operates in the buck mode to obtain a second arithmetic value, then divides the output voltage by the input voltage to obtain a second value, then multiplies the second value by the on-time of the fourth switch operating in the boost mode to obtain a third arithmetic value, and then adds up the second arithmetic value and the third arithmetic value to obtain a compensated on-time;
wherein, in the buck-boost mode, the control circuit controls the on-time of the second switch to be equal to the compensated on-time.

7. The power converter according to claim 1, wherein the control circuit includes:
a buck on-time setting circuit configured to set the on-time of each of the plurality of switch components operating in the buck mode to output a buck on-time signal;
a boost on-time setting circuit configured to set the on-time of each of the plurality of switch components operating in the boost mode to output a boost on-time signal; and
an on-time compensating circuit connected to the buck on-time setting circuit, the boost on-time setting circuit and the control terminal of each of the plurality of switch components, wherein the on-time compensating circuit controls the on-time of each of the plurality of switch components operating in the buck mode according to the buck on-time signal, and controls the on-time of each of the plurality of switch components operating in the boost mode according to the boost on-time signal
wherein the on-time compensating circuit compensates the on-times of a number of the plurality of switch components operating in the buck mode to generate compensated on-times according to the on-time of one of the plurality of switch components operating in the boost mode, and controls the on-times of the number of the plurality of switch components operating in the buck-boost mode to be equal to the compensated on-times respectively.

8. The power converter according to claim 7, wherein the buck on-time setting circuit includes:
a transistor, wherein a control terminal of the transistor is connected to an external on-time instructing circuit and receives an on-time preset signal from the external on-time instructing circuit;
a current source having an input terminal connected to the input node;
a capacitor, wherein a first terminal of the capacitor is connected to an output terminal of the current source and a first terminal of the transistor, and a second terminal of the transistor and a second terminal of the capacitor are grounded;
a voltage divider circuit, wherein an input terminal of the voltage divider circuit is connected to the output node; and
a comparator, wherein a first input terminal of the comparator is connected to the first terminal of the capacitor, a second input terminal of the comparator is connected to an output terminal of the voltage divider circuit, and an output terminal of the comparator is connected to the control terminal of the first switch.

9. The power converter according to claim 8, wherein the voltage divider circuit includes:
a first voltage dividing resistor, wherein a first terminal of the first voltage dividing resistor is connected to the output node; and
a second voltage dividing resistor, wherein a first terminal of the second voltage dividing resistor is connected to a second terminal of the first voltage dividing resistor, a second terminal of the second voltage dividing resistor is grounded, and a node between the first terminal of the second voltage dividing resistor and the second terminal of the first voltage dividing resistor is connected to the second input terminal of the comparator.

10. The power converter according to claim 7, wherein the buck on-time setting circuit includes:
an operational amplifier, wherein a first input terminal of the operational amplifier is connected to the input node;
a first transistor, wherein a control terminal of the first transistor is connected to an output terminal of the operational amplifier;
a current mirror, wherein an input terminal of the current mirror is connected to a first terminal of the first transistor;
a resistor, wherein a first terminal of the resistor is connected to a second terminal of the first transistor and a second input terminal of the operational amplifier, and a second terminal of the resistor is grounded; and
a comparator, wherein a first input terminal of the comparator is connected to an output terminal of the current mirror, a second input terminal of the comparator is connected to the output node, and an output terminal of the comparator is connected to the on-time compensating circuit;
wherein the on-time compensating circuit compensates a buck on-time signal from the output terminal of the comparator to generate a compensated on-time, and controls the on-times of one or more of the plurality of switch components operating in the buck-boost mode to be equal to the compensated on-time.

11. The power converter according to claim 10, wherein the buck on-time setting circuit further includes:
a capacitor, wherein a first terminal of the capacitor is connected to the first input terminal of the comparator, and a second terminal of the capacitor is grounded.

12. The power converter according to claim 10, wherein the current mirror includes:
a second transistor, wherein a first terminal of the second transistor is coupled with a common voltage, and a second terminal of the second transistor is used as an input terminal of the current mirror; and
a third transistor, wherein a first terminal of the third transistor is coupled with the common voltage, a control terminal of the third transistor is connected to a control terminal and the second terminal of the second transistor, and a second terminal of the third transistor is used as an output terminal of the current mirror.

13. The power converter according to claim 12, wherein the buck on-time setting circuit further includes:
a fourth transistor, wherein a first terminal of the fourth transistor is connected to the first input terminal of the comparator, a second terminal of the fourth transistor is grounded, and a control terminal of the fourth transistor receives a setting signal from an external setting circuit.

14. The power converter according to claim 7, wherein the boost on-time setting circuit includes:
a first operational amplifier, wherein a first input terminal of the first operational amplifier is connected to the input node;
a first transistor, wherein a control terminal of the first transistor is connected to an output terminal of the first operational amplifier;
a first current mirror, wherein an input terminal of the first current mirror is connected to a first terminal of the first transistor;
a first resistor, wherein a first terminal of the first resistor is connected to a second terminal of the first transistor and a second input terminal of the first operational amplifier, and a second terminal of the first resistor is grounded;
a second operational amplifier, wherein a first input terminal of the second operational amplifier is connected to the output node;
a second transistor, wherein a first terminal of the second transistor is connected to an output terminal of the first current mirror, and a control terminal of the second transistor is connected to an output terminal of the second operational amplifier;
a second resistor, wherein a first terminal of the second resistor is connected to the second terminal of the second resistor and a second input terminal of the second operational amplifier, and a second terminal of the second resistor is grounded; and
a comparator, wherein a first input terminal of the comparator is connected to the first terminal of the second transistor, and the second input terminal of the comparator is coupled with a reference voltage.

15. The power converter according to claim 14, wherein the boost on-time setting circuit further includes:
a second current mirror, wherein an input terminal of the second current mirror is connected to the first terminal of the second transistor; and
a third resistor, wherein a first terminal of the third resistor is connected to an output terminal of the second current mirror, and the second input terminal of the comparator is connected to a node between the first terminal of the third resistor and the output terminal of the second current mirror.

16. The power converter according to claim 15, wherein the boost on-time setting circuit further includes:
a third operational amplifier, wherein a first input terminal of the third operational amplifier is connected to the output node;
a third transistor, wherein a first terminal of the third transistor is connected to the second input terminal of the comparator, and a control terminal of the third transistor is connected to an output terminal of the third operational amplifier; and
a fourth resistor, wherein a first terminal of the fourth resistor is connected to a second terminal of the third transistor and a second input terminal of the third operational amplifier, and a second terminal of the fourth resistor is grounded.

17. The power converter according to claim 16, wherein the boost on-time setting circuit further includes:
a fourth transistor, wherein a first terminal of the fourth transistor is connected to the first input terminal of the comparator, a second terminal of the fourth transistor is grounded, and a control terminal of the fourth transistor receives a setting signal from an external setting circuit.

18. The power converter according to claim 16, wherein the boost on-time setting circuit further includes:
a third current mirror, wherein an input terminal of the third current mirror is connected to the first terminal of the third transistor, and an output terminal of the third current mirror is connected to the second input terminal of the comparator.

19. The power converter according to claim 14, wherein the boost on-time setting circuit further includes:
a capacitor, wherein a first terminal of the capacitor is connected to the first input terminal of the comparator, and a second terminal of the capacitor is grounded.
